(19) United States
(12) Patent Application Publication
(10) Pub. No.: US 2025/0234448 A1
(43) Pub. Date: Jul. 17, 2025

(54) ON-AXIS TYPE EUV LIGHT SOURCE DEVICE WITH TARGET MATERIAL SUPPLY CHANNEL

(71) Applicant: ESOL, Inc., Hwaseong-si (KR)

(72) Inventor: Dong Gun LEE, Hwaseong-si (KR)

(73) Assignee: ESOL, Inc., Hwaseong-si (KR)

(21) Appl. No.: 18/954,393

(22) Filed: Nov. 20, 2024

(30) Foreign Application Priority Data
Jan. 11, 2024 (KR) 10-2024-0004849
Aug. 5, 2024 (KR) 10-2024-0104108

(51) Int. Cl. H05G 2/00

(52) U.S. Cl. CPC H05G 2/0086; H05G 2/0023

(57) ABSTRACT

The present invention relates to an on-axis type EUV light source device with a target material supply channel, including: a rotational disk having a rotational disk rim which melts a target material for generating EUV light through plasma reactions; a plurality of rotational disk ribs supporting the rotational disk rim so that EUV light penetrates relative to a predetermined area among a light focusing region; and a supply channel formed on each rotational disk rib to supply the target material to the rotational disk rim, wherein the rotational disk ribs supporting the rotational disk rim are configured to allow EUV light to penetrate relative to a predetermined area of a light focusing region through a collector mirror.

### CROSS REFERENCE TO RELATED APPLICATION OF THE DISCLOSURE

The present application claims the benefit of Korean Patent Application Nos. 10-2024-0004849 filed on Jan. 11, 2024, and 10-2024-0104108 filed on Aug. 5, 2024, the entire contents of which are incorporated herein by reference.

### BACKGROUND OF THE INVENTION

### Field of the Invention

The present invention relates to an on-axis type EUV light source device with a target material supply channel, and more specifically, to an on-axis type EUV light source device with a target material supply channel, which can significantly enhance light collection efficiency.

### Background Art

Methods for producing EUV light include a process of converting a material into a plasma state which has at least one element, such as xenon, lithium or tin, with at least one emission line within the EUV range. In one of the methods, required plasma, often referred to as laser-produced plasma (LPP), can be produced by irradiating a target material containing line-emitting elements required as a laser beam.

One specific LPP technique involves irradiating target material droplets to one or more pre-pulses and main pulses.

In this context, a CO₂ laser can provide specific advantages when a driving laser produces the “main pulse” in an LPP process. This may be especially true for certain target materials, such as tin droplets, For example, one advantage may include the ability to produce a relatively high conversion efficiency, for instance, a ratio between the drive laser input power and the output EUV in-band power.

Light source devices generating EUV light are generally categorized into an off-axis structure and an on-axis structure, and include a rotator-type target material feeder, which stably induces an reflection angle of an optical system and a plasma reaction. The rotor-type light source devices supplying target materials have been widely adopted in conventional technologies due to their ability to stably induce plasma reactions. The rotor-type light source devices are typically designed with off-axis type light output structures depending on light output structures.

The off-axis structure is advantageous in terms of optical system arrangement, but is disadvantageous in that light collection efficiency is deteriorated.

### PATENT LITERATURE

### Patent Documents

Patent Document 1: Korean Patent No. 10-1811306
Patent Document 2: Korean Patent No. 10-0875569
Patent Document 3: Korean Patent No. 10-2207666
Patent Document 4: Korean Patent No. 10-1484937
Patent Document 5: Korean Patent Publication No. 10-2011-0110578
Patent Document 6: Korean Patent Publication No. 10-2008-0041671

### SUMMARY OF THE INVENTION

Accordingly, the present invention has been made to solve the above-mentioned problems occurring in the prior arts, and it is an objective of the present invention to provide an on-axis type EUV light source device with a target material supply channel, which can significantly enhance light collection efficiency by improving the light focusing structure while maintaining the existing target material supply system requiring the plasma reaction for the EUV light generation.

Specifically, an objective of the present invention is to provide an objective of the present invention is to provide an optical system of an on-axis structure in an EUV light generation device of a rotational disc structure to supply target materials continuously and stably, thereby significantly enhancing light collection efficiency.

To accomplish the above objective, according to the present invention, there is provided an on-axis type EUV light source device with a target material supply channel, including: a rotational disk having a rotational disk rim which melts a target material for generating EUV light through plasma reactions; a plurality of rotational disk ribs supporting the rotational disk rim so that EUV light penetrates relative to a predetermined area among a light focusing region; and a supply channel formed on each rotational disk rib to supply the target material to the rotational disk rim, wherein the rotational disk ribs supporting the rotational disk rim are configured to allow EUV light to penetrate relative to a predetermined area of a light focusing region through a collector mirror, which irradiates the beam emitted from a laser source to the target material by penetrating the beam to the center, receive the EUV light reflected from the target material, and collect the EUV light to the same incident light axis.

Moreover, the rotational disk ribs are arranged between the rotational disk hub and the rotational disk rim, and the rotational disk ribs are configured to block only 5% to 20% of the light passing through, and are arranged in such a way that an EUV light transmissive area in the light focusing region where the EUV light is connected through the collector mirror is greater than a blocking area.

Furthermore, the collector mirror further includes a cleaning means for removing scattered fragments.

Additionally, the EUV light source device further includes a droplet feeder for supplying the target material to the supply channel.

In addition, the supply channel receives the target through the droplet feeder, which supplies the target material material to the center of the rotational disk hub, and a supply tube for delivering the target material from the rotational disk hub to the supply channel is coupled to the supply channel.

Moreover, the rotational disk hub includes: a storage hole, which is provided at the center thereof and has a closure surface with an open top and a closed bottom to store the droplets; and a plurality of discharge holes provided in the closure surface of the storage hole to discharge the droplets.

Furthermore, the supply tube is screw-coupled to a screw-coupling part of the discharge hole formed on the side of the rotational disk hub.

Additionally, the supply tube further comprises an expansion part which expands a cross-sectional supply area to the end through which the target material is discharged.

In addition, three, four, six, or eight supply tubes are formed on the rotational disk hub to maintain balance during the rotational operation of the rotational disk.

Moreover, the supply tube extends from the rotational disk hub to the rotational disk rim.

Furthermore, the central portion of the closure surface is formed higher than the surrounding area, allowing the droplets to flow into the discharge holes.

Additionally, a lower portion of the discharge holes is positioned lower than a lower portion of the closure surface, so that the entire droplets can be moved and discharged through the discharge holes.

The present invention having the above configuration can provide an on-axis type EUV light source device, which can provide excellent light collection efficiency through the arrangement of the collector mirror and the structure of the rim formed on the rotational disk to maintain the target material supply structure according to plasma reactions of the EUV light source device and realize the on-axis structure.

### BRIEF DESCRIPTION OF THE DRAWINGS

FIG. 1 is an overall configuration of an on-axis type EUV light source device with a target material supply channel according to the present invention.

FIG. 2 is a plan view of an on-axis type EUV light source device with a target material supply channel according to an embodiment of the present invention.

FIG. 3 is a plan view of an on-axis type EUV light source device with a target material supply channel according to another embodiment of the present invention.

FIG. 4 is a plan view of an on-axis type EUV light source device with a target material supply channel according to a further embodiment of the present invention.

FIG. 5 is a cross-sectional view of a rotational disk from FIG. 4.

FIG. 6 is a plan view of an on-axis type EUV light source device with a target material supply channel according to a still further embodiment of the present invention.

FIG. 7 is a plan view of a shield of the on-axis type EUV light source device with the target material supply channel according to the present invention.

FIG. 8 is a plan view illustrating a state in which the on-axis type EUV light source device with the target material supply channel is arranged in an off-axis configuration according to the present invention.

FIG. 9 is a plan view of a rotational disk hub and a supply tube according to the present invention.

FIG. 10 is a detailed view illustrating an installed state of the rotational disk hub and the supply tube according to the present invention.

FIG. 11 is a detailed view of the supply tube according to the present invention.

FIGS. 12 and 13 are detailed views of the rotational disk hub and the supply tube according to the present invention.

### DETAILED DESCRIPTION OF THE PREFERRED EMBODIMENT

Hereinafter, an on-axis type EUV light source device with a target material supply channel according to the present invention will be described in detail with reference to the accompanying drawings.

The on-axis type EUV light source device with the target material supply channel according to the present invention includes: a rotational disk having a rotational disk rim which melts a target material for generating EUV light through plasma reactions; a plurality of rotational disk ribs supporting the rotational disk rim so that EUV light penetrates relative to a predetermined area among a light focusing region; and a supply channel formed on each rotational disk rib to supply the target material to the rotational disk rim. The rotational disk ribs supporting the rotational disk rim are configured to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

The on-axis type EUV light source device with a target material supply channel, according to the present invention, applies a target material supply device with a superior structure for generating an EUV light source and applies an on-axis type light focusing structure, thus significantly enhancing light collection efficiency compared to conventional EUV light source devices.

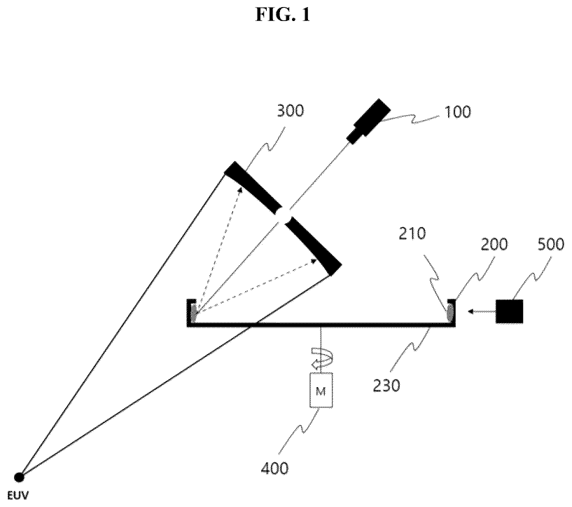

FIG. 1 is an overall configuration of an on-axis type EUV light source device with a target material supply channel according to the present invention.

The EUV light source device according to the present invention primarily includes: a laser source 100, a rotational disk 200 which confines molten target material in a reaction space using centrifugal force for plasma reactions; a heating means 500 for melting the target material 210 located in the reaction space of the rotational disk 200; and a collector mirror 300 which irradiates the beam output from the laser source 100 to the target material by allowing the beam to pass centrally, receives the reflected EUV light, and collects the EUV light to the same incident light axis. According to the technical concept of the present invention, the rotational disk 200 includes rotational disk ribs 230 with a penetration structure relative to a predetermined area among the light focusing region where the EUV light is focused through the collector mirror 300.

In one embodiment of the present invention, the laser source 100 may be a laser source with a pulse frequency ranging from 50 kHz to 200 kHz.

Additionally, the RPM of the rotational disk 200 can be determined according to the pulse repetition rate of the laser source, and the rotational speed of the rotational disk can be determined by a laser repetition rate.

Accordingly, a portion of the EUV light collected and output by the collector mirror 300 is designed to pass through (or penetrate) the rotational disk ribs 230 of the rotational disk 200 in an on-axis type optical output structure, thus effectively solving the problem of conventional arts where light focusing amount is reduced in the conventional off-axis structures.

Here, the heating means 500 for melting the target material 210 preferably surrounds the exterior of the rotational disk and heats the target material supplied to the inner surface (rim) of the rotational disk to melt the target material. The heating means can use various heating elements, such as laser heating, induction methods, or ceramic-based heating elements.

Furthermore, the collector mirror 300 may include a separate heating device (not shown). The heating device can be used in a chamber of the EUV light source device to clean off fragmented target material particles, which may be generated by the target material and might interfere with the optical properties of the collector mirror or other optical systems and components, by heating the collector mirror, optical systems or components. Therefore, the heating device can be adopted as a cleaning means, and can be configured inside the chamber of the EUV light source device to remove fragment particles.

Therefore, the present invention can provide a fragment removal function using the heating device for removing fragments generated by the target material in the rotational disk-based EUV light source device.

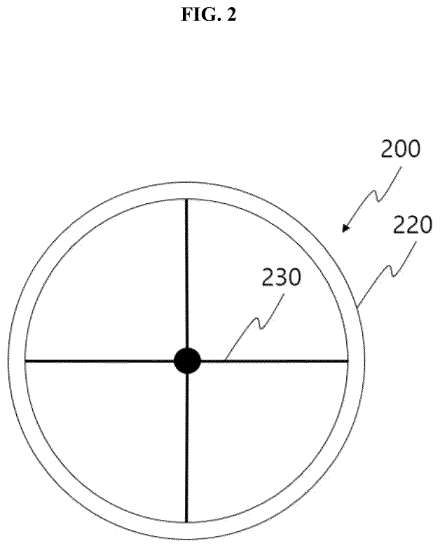

FIG. 2 is a plan view of an on-axis type EUV light source device with a target material supply channel according to an embodiment of the present invention.

FIG. 2 illustrates the rotational disk 200 in a planar view. The rotational disk 200 has a circular structure, and rotates via a driving means. In this instance, the rotational disk 200 includes: a rotational disk rim 220 for holding the target material; and a plurality of rotational disk ribs 230 supporting the rotational disk rim 220 from a rotary shaft.

The plurality of rotational disk ribs 230 are configured to allow EUV light collected by the collector mirror 300 to penetrate when the light is collected in the on-axis manner, such that light focused by the collector mirror 300 can be penetrated.

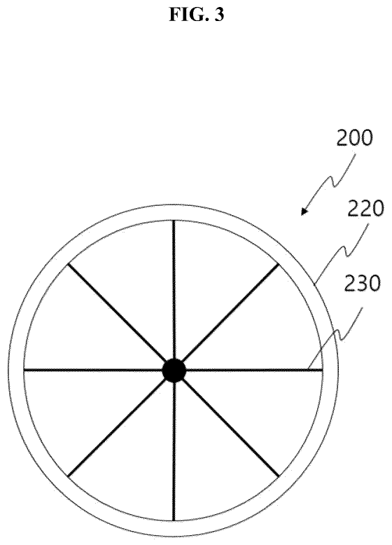

FIG. 3 is a plan view of an on-axis type EUV light source device with a target material supply channel according to another embodiment of the present invention.

The rotational disk ribs 230, preferably, has a spoke structure to minimize interference when the focused EUV light is penetrated.

Since the rotational disk is configured to have a plurality of spokes, the rotational disk ribs of the rotational disk can effectively collect the generated EUV light when collecting the light focused on the collector mirror in the on-axis manner.

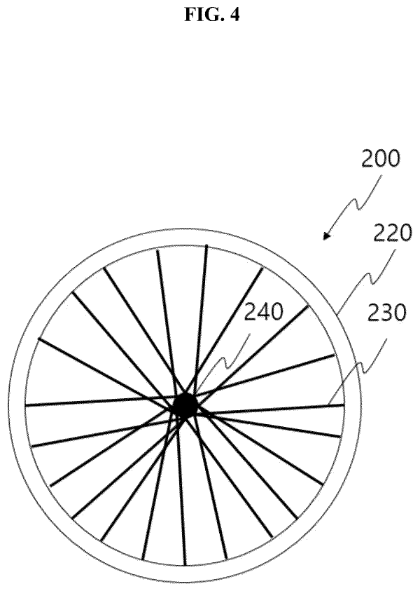

FIG. 4 is a plan view of an on-axis type EUV light source device with a target material supply channel according to a further embodiment of the present invention.

In the present invention, to ensure the structural stability of the rotational disk 200, the rotational disk rim 220, and the rotational disk ribs 230, various coupling structures between the rotational disk rim 220 and the rotational disk ribs 230 can be proposed.

As illustrated, a rotational disk hub 240 may be configured at the rotational center shaft, and the rotational disk ribs 230 are assembled between the rotational disk hub 240 and the rotational disk rim 220 in a cross-type (tangent-type) structure. The cross-type structure is configured such that the plurality of rotational disk ribs (spokes) are intersected to support each other, thereby enhancing rigidity to safely withstand external resistance, such as torsion of the rotational disk rim 220 or lateral impacts, by rotational forces. The number of intersecting rotational disk ribs can range from one to four according to patterns.

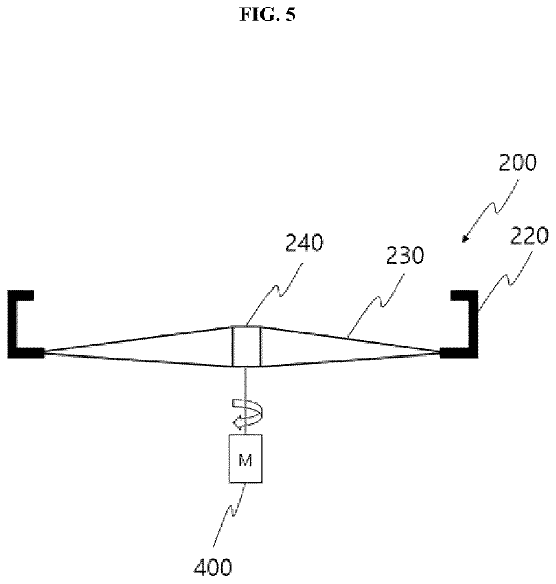

FIG. 5 is a cross-sectional view of a rotational disk from FIG. 4. The rotational disk hub 240 is provided at the rotational disk shaft, and the rotational disk ribs 230 intersect to support the rotational disk rim 220. The rotational disk hub 240 is coupled to a driving means 400 to receive rotational force, confines the target material located on the rotational disk rim 220 by centrifugal force, and reacts with the laser emitted from the laser source to generate EUV light through plasma reactions.

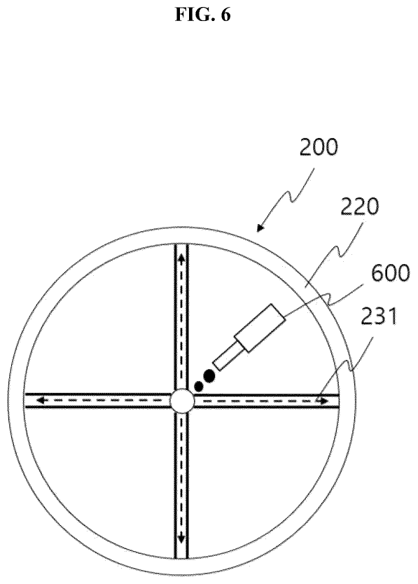

FIG. 6 is a plan view of an on-axis type EUV light source device with a target material supply channel according to a still further embodiment of the present invention.

In the still further embodiment of the present invention, the rotational disk ribs 230 includes supply channels 231 of a predetermined width to supply the target material supplied from a target feeder located, which feeds the target material from the rotational center shaft, to the rotational disk rim. A droplet feeder 600 for supplying the target material is positioned above the center shaft.

When the plasma reactions are induced to generate EUV light, the target material positioned on the rotational disk rim decreases, and the droplet feeder 600 continuously supplies the reduced amount of target material, thus providing stable plasma reactions.

As described above, the on-axis type EUV light source device can provide excellent light collection efficiency through the arrangement of the collector mirror and the structure of the rim formed on the rotational disk to maintain the target material supply structure according to plasma reactions of the EUV light source device and realize the on-axis structure.

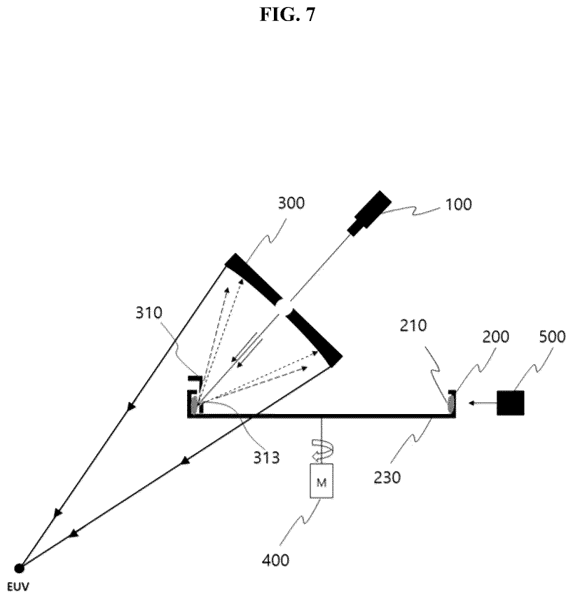

FIG. 7 is a plan view of a shield of the on-axis type EUV light source device with the target material supply channel according to the present invention. Since fragmented target material particles may be generated by the target material in the EUV light source device on the collector mirror and a plurality of optical systems or components and might interfere with the optical properties, a shield 310 for blocking the fragmented particles can be arranged.

The shield 301 is positioned to surround the target material placed on the rotational disk rim, thereby preventing fragment particles generated from the target material.

In this instance, the shield includes a single through-hole 313 to allow the beam emitted from the laser source 100 to irradiate to the target material and allow the collector mirror 300 to receive the EUV light reflected from the target material. The single through-hole can be used as a penetration hole through which the incident beam irradiated to the target material and the reflective beam reflected from the target material pass.

If two holes are formed in the shield for the incident beam and the reflective beam, there may occur a problem in arrangement of the incident beam and the reflective beam due to interference between the two holes. However, using a single through-hole solves the problem.

Accordingly, the shield with the single hole is advantageous for collecting EUV light over a wide solid angle and blocking simultaneously generated fragments from the optical systems.

The present invention has been described primarily in terms of the on-axis method, but can also be configured in an off-axis manner if necessary.

That is, as occasion demands, the collector mirror for collecting EUV light may have a spherical, aspherical, or elliptical shape to collect light in an on-axis manner or in an off-axis manner.

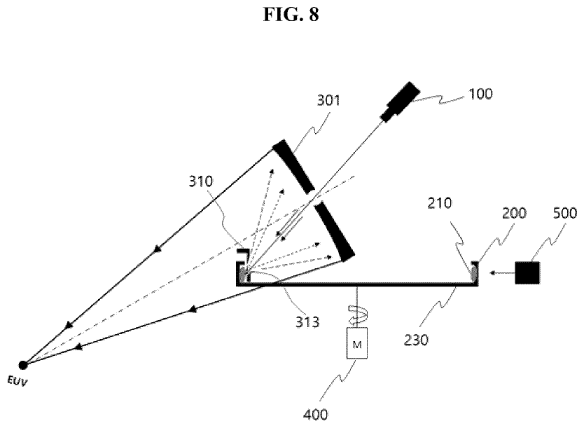

FIG. 8 is a plan view illustrating the EUV light source device with the off-axis type light collection structure to which for the target material feeder with an excellent structure generating EUV light is applied.

As illustrated in FIG. 8, the shield includes a single through-hole 313 to allow the beam emitted from the laser source 100 to irradiate to the target material and allow the collector mirror 300 to receive the EUV light reflected from the target material. The single through-hole can be used as a penetration hole through which the incident beam irradiated to the target material and the reflective beam reflected from the target material pass.

The beam incident on an off-collector mirror 301 is collected to generate EUV light. At this time, an off-center axis C2 of the off-collector mirror 301 is not parallel to a center axis C1 of the laser beam emitted from the laser source and incident on the target material, thus the off-center axis C2 of the off-collector mirror 301 and the center axis C1 of the laser beam form an off-axis configuration.

Such an arrangement helps to avoid interference with peripheral equipment or the rotational disk.

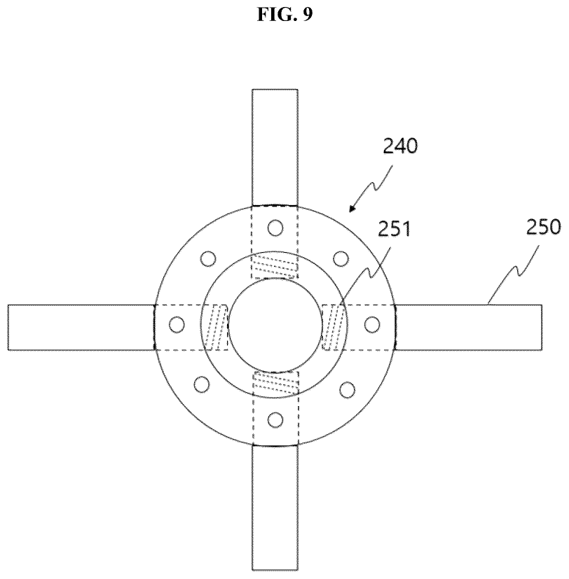

FIG. 9 is a plan view of a rotational disk hub and a supply tube according to the present invention.

In the configuration illustrated in FIG. 6, the structure where when droplets are supplied through a droplet feeder 600 at the center, the target material is supplied to the rotational disk rim via the supply channel formed on the rotational disk ribs. However, if only the supply channel is simply formed, the target material may escape externally during the rotation of the rotational disk.

Accordingly, the present invention further includes cylindrical supply tubes 250 which are coupled with the rotational disk hub 240 to stably supply the target material to the rotational disk rim.

As illustrated, the supply tubes 250 are configured on all four sides (top, bottom, left, right) of the rotational disk hub 240. The number of supply tubes 250 should preferably be matched to prevent imbalance during the rotational operation of the rotational disk. For instance, three, four, six, eight, or ten supply tubes may be formed.

The supply tubes 250 are respectively coupled to holes formed on the sides of the rotational disk hub 240 through coupling parts 251. The central portion and the holes of the rotational disk hub 240 have a through structure. The target material is supplied to the central portion through the droplet feeder located outside, and then, is transmitted to the supply tubes 250 through the holes.

The supply tube 250 has a cylindrical structure that extends to the rotational disk rim 220 to supply the target material. Alternatively, only a predetermined length of the supply tube 250 extends and the remaining portion allow the target material to be supplied through the supply channels 231 formed on the rotational disk ribs.

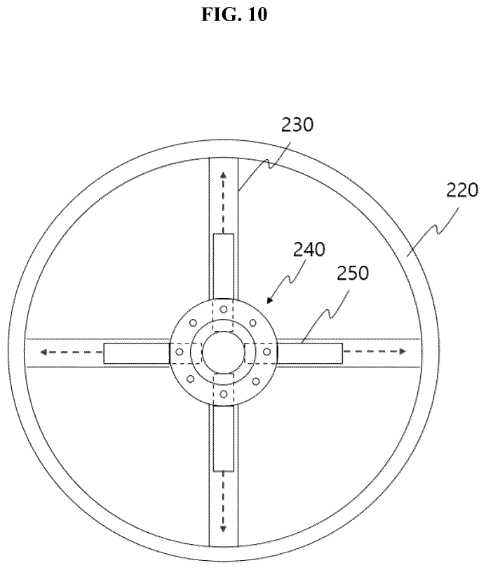

FIG. 10 is a detailed view illustrating an installed state of the rotational disk hub and the supply tube according to the present invention. As illustrated, four supply tubes 250 are coupled to all four sides of the rotational disk hub 240, and are aligned on the same line with the rotational disk ribs 230 to supply the target material.

As previously mentioned, the supply tubes 250 can have the same length as the rotational disk ribs 230 or extend only to a predetermined length to deliver the target material to the rotational disk rim 220.

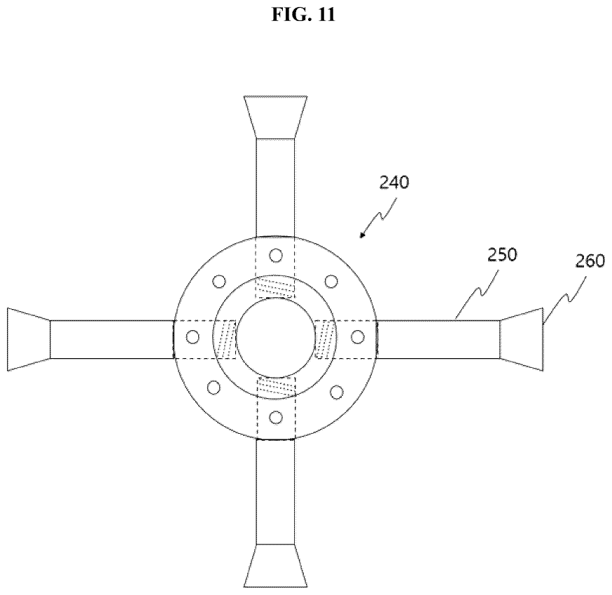

FIG. 11 is a detailed view of the supply tube according to the present invention. As illustrated, an expansion part 260 is connected to the end of the supply tube 250. The expansion part 260 transforms the circular cross-section of the supply tube 250 into an elliptical cross-section, and is coupled to the end of the supply tube 250 so that the target material is spread more effectively when the target material is supplied.

In other words, the expansion part 260 expands the cylindrical area, which is the cross-section of the supply tube, or is formed in an elliptical shape, facilitating the spreading of the target material.

In this instance, the expansion part 260 can either be assembled to the end of the supply tube 250 using a separate component or formed by expanding from the compressed end of the supply tube after the end of the supply tube is compressed. Preferably, the supply tube 250 may be made of a metallic material, and the expansion part 260 can be formed by compressing the end of the supply tube.

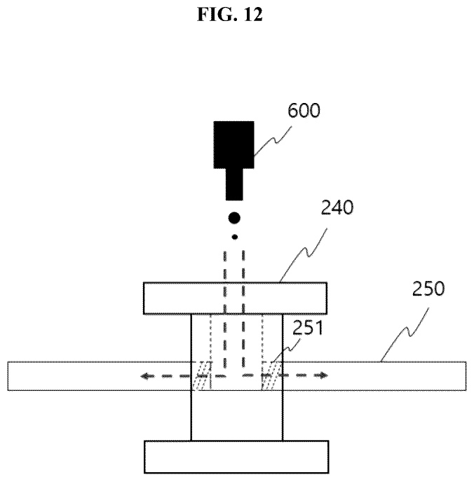

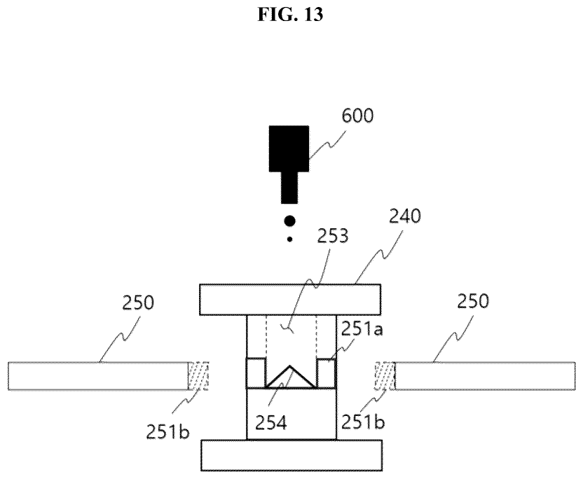

FIGS. 12 and 13 are side-sectional views of the rotational disk hub and the supply tube according to the present invention. The end of the supply tube 250, which is coupled to the hole formed on the rotational disk hub 240, has a coupling part 251 formed to be screw-coupled, so the hole of the rotational disk rib is communicated with a hollow portion of the rotational disk and extends to the supply tube 250.

Therefore, when the target material is supplied through the droplet feeder 600 positioned above the rotational disk hub 240, the target material flows into the hollow portion of the rotational disk hub and is then supplied into the supply tube 250.

Additionally, the rotational disk hub includes: a storage hole 253, which is provided at the center thereof and has a closure surface 254 with an open top and a closed bottom to store the droplets; and a plurality of discharge holes 251a provided in the closure surface of the storage hole to discharge the droplets. Accordingly, the supply tube is screw-coupled to a screw-coupling part of the discharge hole 251a formed on the side of the rotational disk hub.

Furthermore, the central portion of the closure surface 254 is formed higher than the surrounding area, allowing the droplets to flow into the discharge holes 251a and to be discharge out. Such a configuration is to easily control the flow of the droplets.

Although not illustrated in the drawings, a lower portion of the discharge holes is positioned lower than a lower portion of the closure surface, so that the entire droplets can be moved and discharged through the discharge holes 251a.

While the preferred embodiments of the present invention have been described and illustrated to exemplify the principles of the present invention, the present invention is not limited to the aforementioned specific embodiments. It will be appreciated to those skilled in the art that the present invention can be changed and modified in various manners without departing from the spirit and scope of the present invention. Accordingly, all proper changes, modifications, and equivalents should be construed as belonging to the scope of the present invention.

What is claimed is:

1. An on-axis type EUV light source device with a target material supply channel, comprising:
a rotational disk having a rotational disk rim which melts a target material for generating EUV light through plasma reactions;
a plurality of rotational disk ribs supporting the rotational disk rim so that EUV light penetrates relative to a predetermined area among a light focusing region; and
a supply channel formed on each rotational disk rib to supply the target material to the rotational disk rim,
wherein the rotational disk ribs supporting the rotational disk rim are configured to allow EUV light to penetrate relative to a predetermined area of a light focusing region through a collector mirror, which irradiates the beam emitted from a laser source to the target material by penetrating the beam to the center, receives the EUV light reflected from the target material, and collects the EUV light to the same incident light axis.

2. The EUV light source device according to claim 1, wherein the rotational disk ribs are arranged between the rotational disk hub and the rotational disk rim, and
wherein the rotational disk ribs are configured to block only 5% to 20% of the light passing through, and are arranged in such a way that an EUV light transmissive area in the light focusing region where the EUV light is connected through the collector mirror is greater than a blocking area.

3. The EUV light source device according to claim 1, wherein the collector mirror further includes a cleaning means for removing scattered fragments.

4. The EUV light source device according to claim 1, further comprising:
a droplet feeder for supplying the target material to the supply channel.

5. The EUV light source device according to claim 1, wherein the supply channel receives the target material through the droplet feeder, which supplies the target material to the center of the rotational disk hub, and a supply tube for delivering the target material from the rotational disk hub to the supply channel is coupled to the supply channel.

6. The EUV light source device according to claim 5, wherein the rotational disk hub includes:
a storage hole, which is provided at the center thereof and has a closure surface with an open top and a closed bottom to store the droplets; and
a plurality of discharge holes provided in the closure surface of the storage hole to discharge the droplets.

7. The EUV light source device according to claim 6, wherein the supply tube is screw-coupled to a screw-coupling part of the discharge hole formed on the side of the rotational disk hub.

8. The EUV light source device according to claim 5, wherein the supply tube further comprises an expansion part which expands a cross-sectional supply area to the end through which the target material is discharged.

9. The EUV light source device according to claim 4, wherein three, four, six, or eight supply tubes are formed on the rotational disk hub to maintain balance during the rotational operation of the rotational disk.

10. The EUV light source device according to claim 5, wherein the supply tube extends from the rotational disk hub to the rotational disk rim.

11. The EUV light source device according to claim 6, wherein the central portion of the closure surface is formed higher than the surrounding area, allowing the droplets to flow into the discharge holes.

12. The EUV light source device according to claim 10, wherein a lower portion of the discharge holes is positioned lower than a lower portion of the closure surface, so that the entire droplets can be moved and discharged through the discharge holes.
